(19) United States
(12) Patent Application Publication
(10) Pub. No.: US 2008/0268108 A1
(43) Pub. Date: Oct. 30, 2008

(54) Hurdle Technology for Producing Shelf-Stable Guacamole

(76) Inventors: Sevugan Palaniappan, Plano, TX (US); Richard Metivier, Highland Village, TX (US); John Mampra Mathew, Plano, TX (US)

Correspondence Address: CARSTENS & CAHOON, LLP, P O BOX 802334, DALLAS, TX, 75380, US

(21) Appl. No.: 11/739,331

(22) Filed: Apr. 24, 2007

(51) Int. Cl. A23B 7/055

(52) U.S. Cl. 426/131

(57) ABSTRACT

A method is disclosed for producing shelf-stable guacamole. A number of hurdles to the contamination of the guacamole are put into place during mixing, packaging, and post-packaging processing. Antimicrobial additives are added during mixing. The amount of oxygen allowed inside the guacamole container is reduced during packaging. After packaging, the guacamole is subjected to high pressure and mild thermal processing.

### BACKGROUND OF THE INVENTION

1. Technical Field

The present invention relates to a method and system for producing shelf-stable guacamole.

2. Background

Guacamole is an avocado-based dip or spread. It is made by mashing avocados and mixing them with other ingredients that can include onion, tomato, chili peppers, garlic, coriander, and other spices. The avocado is a unique, low acid, high oil fruit, which generally comprises one large central seed covered by a layer of edible green-colored flesh, which in turn is covered by a thin layer of protective skin. More than 70% of the oil in avocados are polyunsaturated and monounsaturated oils, which help reduce cholesterol buildup on arterial walls. However, the high oil content helps turn avocado flesh rancid quickly after it is exposed to oxygen. This occurs because oxygen degrades the oil, which causes rancidity. In fact, fresh guacamole, if left untreated, typically has a shelf life of less than 3 days.

Furthermore, the low acidity of the avocado allows bacteria spores and vegetative cells to grow and thrive within the avocado flesh. The most common method of killing harmful organisms within food products is through thermal processing. However, avocado is one of the most difficult fruits to thermally process because during thermal processing, the avocado's enzymes cause significant browning and bitterness to develop in the avocado flesh. Thermal processing can also cause some of the oil within the avocado to separate from the flesh. Simply put, the desirable characteristics of guacamole, such as its flavor, texture, and green color, cannot withstand the time and temperature required to inactivate microbes and make it shelf stable. Shelf-stable guacamole is guacamole that retains its flavor and microbiologically stable for at least three months at room temperature. Hence, it is not possible to produce guacamole which is shelf-stable and has an acceptable flavor using thermal processing alone.

No prior art process has been able to produce a shelf-stable guacamole. Accordingly, a need exists for a process for making shelf-stable guacamole that has an acceptable flavor and color.

### SUMMARY OF THE INVENTION

The invention comprises a method and system for producing shelf-stable guacamole. Shelf-stable guacamole is guacamole that retains its desirable flavor, texture, green color, and sterility for at least three months at room temperature. The shelf-stable guacamole of the present invention is produced using hurdle technology, whereby several different hurdles to rancidity and bacteria formation are erected. The hurdles are carefully chosen so that the flavor, texture, green color and other desirable characteristics of the guacamole are retained. By placing particular hurdles in the appropriate places during the processing steps, the guacamole is sufficiently sterilized so that it becomes shelf-stable.

The first hurdle is designed to inhibit the growth of microbes and reduce browning by reducing the pH of the guacamole below about 4.6. The acidic environment inhibits enzymatic browning and bacterial growth within the guacamole, and helps inactivate any microbes present.

The second hurdle involves including at least one anti-microbial additive in the guacamole mixture. The anti-microbial additives of the second hurdle are particularly effective against mold and yeast microbes.

The third hurdle reduces enzymatic browning by including at least one anti-browning agent. Tile anti-browning agents inhibit the activity of the polyphenol oxidase enzyme and other enzymes in the guacamole that contribute to enzymatic browning.

The fourth hurdle is optional, and provides a lower level of microbes in the guacamole initially. Options for the fourth hurdle include using low- or zero-bacteria ingredients, clean room conditions during processing, and using sterile packaging materials.

The fifth hurdle is aimed towards reducing the amount of oxygen present inside the product packaging. In one embodiment, this is accomplished by using packaging material that has low oxygen permeability. In another embodiment, the interior of the packaging is flushed with an inert gas, such as nitrogen, before it is sealed. In still another embodiment, the oxygen is removed under vacuum.

For the sixth hurdle, which is optional, the packaged guacamole is subjected to high pressure and/or high temperature. In one embodiment, the guacamole is exposed to pressures of about 90,000 pounds per square inch for between about 20 seconds and about 3 minutes. The elevated pressures inactivate most of the vegetative bacteria. Mild thermal processing can also be used in the sixth hurdle to reduce the number of viable bacterial spores in the guacamole. In one embodiment, the guacamole is heated to temperatures of between about 130° F. and about 160° F. for between about 2 minutes and about 20 minutes.

By combining these different hurdles to browning and contamination by microbes in guacamole, a shelf-stable guacamole is produced which can remain commercially sterile and retain its desirable organoleptical and visual characteristics for at least three months at room temperature. The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flow chart showing the process for producing shelf-stable guacamole.

### DETAILED DESCRIPTION

The present invention is a method and system for producing shelf-stable guacamole. Shelf-stable guacamole is guacamole that remains green (does not turn brown) and remains commercially sterile for at least 3 months at room temperature. The shelf-stable guacamole is produced using one or more “hurdles”, each of which prevents browning or microbial growth, or both. The combination of hurdles is carefully chosen so that the flavor, texture and desirable green color of the guacamole are retained while the level of microbes is reduced to a point that is safe for human consumption, and while the ability of microbes to thrive in the guacamole is reduced. As used herein, the term microbe includes bacteria, mold, fungi, and other organisms that are able to contaminate food.

The first step in the process for making shelf-stable guacamole is mixing the avocado flesh 104 with the other ingredients 106 of the guacamole together in a blend tank 102. Guacamole utilizes avocado flesh as a primary ingredient. Optionally, other ingredients such as onion, tomato, chili peppers, garlic, coriander, and other spices can be added to taste. It is during the nixing step that the first hurdle, which helps prevent microbial growth and enzymatic browning, is put in place. The first hurdle comprises adding one or more acids as an ingredient to reduce the pH of the guacamole. In one embodiment, acid is added to the guacamole in order to bring the pH of the guacamole mixture down to a level below about 4.6. In a preferred embodiment, the pH of the guacamole is reduced to a level below about 4.4. The guacamole's resultant acidic environment reduces the number of viable microbes present, inhibits their continued growth and prevents bacterial spores from germinating. Generally, the acid used can comprise one or more food grade acids that are safe for human consumption. In one embodiment, one or more acids are chosen from the following group: acetic acid, acidified calcium sulfate, ascorbic acid, fumaric acid, citric acid, tartaric acid, malic acid, phosphoric acid, gluconic acid, lactic acid and glucono delta lactone (GDL). In a preferred embodiment, ascorbic acid, GDL and/or acetic acid are the acidic additives used for the first hurdle.

A second hurdle, which is also put in place during the mixing step, helps reduce microbial growth. The second hurdle comprises adding to the guacamole one or more antimicrobial additives as ingredients. As used herein, the term antimicrobial additive means an edible chemical food additive that reduces the level of microbes in the food. In one embodiment, one or more suitable anti-microbial additives are chosen from the following group: nicin, sorbic acid mineral salts, cultured whey, cultured dextrose, benzoate, propionate, and parabens. Examples of sorbic acid mineral salts include, without limitation, sodium sorbate, potassium sorbate or calcium sorbate. The anti-microbial additives used in the second hurdle are particularly effective at reducing the amount of yeast and/or mold present in the guacamole ingredients.

A third hurdle put in place during the mixing step prevents enzymatic browning. This hurdle comprises adding to the guacamole at least one anti-browning additive chosen from the following group: sulfur dioxide, chelating agents, 1-cysteine, chloride salts (for example, NaCl), and antioxidants. In one embodiment, the chelating agent is ethylene-diamine-tetraacetic acid (EDTA) and/or phosphate. The term “anti-browning additive” as used herein is a food additive that deactivates or denatures the polyphenol oxidase enzyme and other enzymes in the avocado that contribute to browning of the avocado flesh over time.

A fourth hurdle may optionally be used to reduce the amount of microbes initially present in the guacamole before it is packaged 108. The number of microbes initially present in the guacamole can be reduced by utilizing at least one of the following techniques: clean room conditions for processing and packaging 110; low-bacteria, extra low-bacteria, or zero-bacteria containing ingredients; and sterile packaging. As used herein, the term clean room conditions 110 means that the work area has its temperature and humidity controlled, and has the ability to remove airborne contaminants. There is a continuous influx of clean, dust-free air. The particular level of air cleanliness is typically given as the maximum number of particles larger than 0.5 micrometers per cubic foot of air. For the present invention, the clean room conditions preferably correspond to no more than 100,000 particles larger than 0.5 micrometers allowed per cubic foot of air. As used herein, low-bacteria containing ingredients means ingredients that have less than 300,000 organisms per gram of ingredient. As used herein, extra low-bacteria containing ingredients have less than 100,000 organisms per gram of ingredient. As used herein, zero-bacteria containing ingredients have about zero viable microbes present. Zero-bacteria ingredients can be obtained by, for example, irradiating the ingredients with at least 10 kilogray units of radiation. As used herein, sterilized packaging is packaging material that has about zero viable microbes present on its surface. Packaging can be sterilized, for example, by using steam to kill the microbes present on the packaging surfaces.

A fifth hurdle is used during packaging to prevent enzymatic browning and microbial growth by reducing or eliminating the oxygen present inside the packaging. The fifth hurdle comprises at least one of the following oxygen-reducing techniques: using packaging material that has low oxygen permeability, packaging 108 the guacamole under vacuum conditions, flushing the interior of the guacamole packages 112 with a non-oxygen flushing gas prior to sealing, including an oxygen scavenger inside the sealed packages 112. A material that has low oxygen permeability preferably allows less than 1 cubic centimeter of oxygen per square meter of packaging to pass through it per day. The vacuum packaging preferably leaves the interior of the sealed guacamole package with less than 1% oxygen by volume. Flushing gasses suitable for use with the present invention include nitrogen, carbon monoxide and carbon dioxide. Oxygen scavengers capture oxygen inside the package using a harmless chemical reaction that renders the oxygen unavailable for enzymatic browning reactions or microbial growth. Examples of food grade oxygen scavengers that can be used with the present invention include small sachets containing a fine iron powder covered with sea salt, or a natural zeolite impregnated with a NaCl solution. More advanced oxygen scavengers include oxidizable polymers used on the inner layer of the packaging.

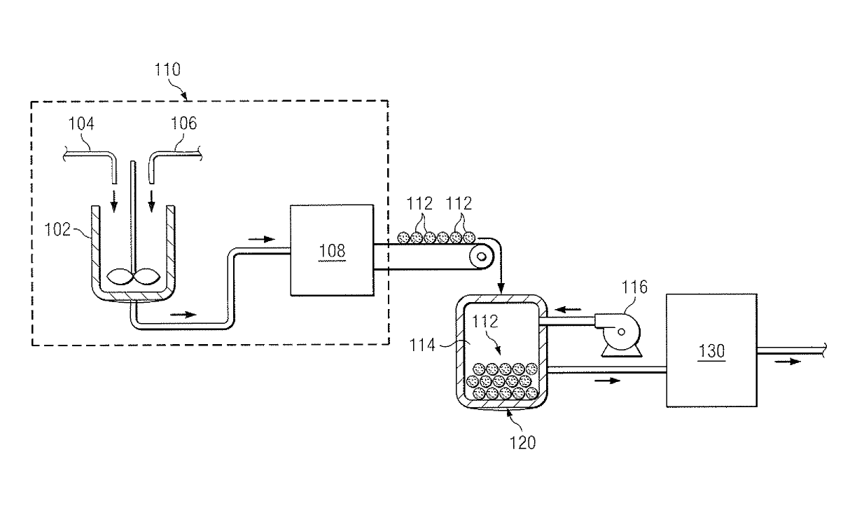

Once the guacamole is packaged, a sixth hurdle is optionally utilized to further reduce the level of microbes present therein by exposing the packaged guacamole to one or a combination of high pressure and high temperature. Specifically, the sixth hurdle optionally comprises subjecting the packaged guacamole to high pressures using a pressurizer 120. In one embodiment, the packaged guacamole 112 is subjected to a pressure of at least about 80,000 pounds per square inch (psi) for at least about 20 seconds. In a preferred embodiment, the packaged guacamole 112 is subjected to at least about 90,000 psi for between about 30 seconds and about 2 minutes. The pressure can be applied to the packaged guacamole by using a pressurizer 120 that submerges the packaged guacamole 112 in a sealed tank 114 filled with pressure fluid, such as water or oil. Pressure is added to the pressurizer 120 by pumping 116 additional pressure fluid into the tank 114 until the desired pressure is obtained. The high pressures of the sixth hurdle disrupt the cell walls of any bacteria present and denature the enzymes that are responsible for the rancidity of stored guacamole. The sixth hurdle also optionally comprises mild thermal processing 130 of the guacamole followed by rapid cooling. This thermal processing can take place either after packaging 108 or after mixing in the blend tank 102. The embodiment depicted in FIG. 1 shows thermal processing 130 occurring after packaging 108. The thermal processing conditions are carefully chosen such that thermal degradation of the avocados does not occur. In one embodiment, the guacamole is heated up to a product temperature between about 130° F. and about 160° F. for between about 2 minutes and about 20 minutes. The thermal processing 130 preferably occurs using a direct heating method, such as microwaving, which heats the packaged guacamole until the desired product temperatures are obtained. Direct heating methods are those methods that are capable of heating the guacamole without transferring heat to the guacamole through an intervening medium, and include microwave heating, ohmic heating, or direct steam injection. However, the optional heating step can be accomplished by any method known in the art. Once the desired product temperature has been obtained for the desired length of time, the guacamole may be rapidly cooled by, for example, submerging the packaged guacamole in cold water. Preferably, the guacamole is cooled to a temperature of less than about 80° F.

The foregoing hurdles can be used to produce shelf-stable guacamole. Shelf-stable guacamole is guacamole that is able to be stored at room temperature (between about 70° F. and about 80° F.) for at least three months while remaining commercially sterile and retaining its desirable green color. Guacamole is “commercially sterile”, as that term is used herein, when there is a growth rate of approximately zero bacteria when the rate of bacteria growth is measured under the same pH and storage conditions of the packaged guacamole.

While the invention has been particularly shown and described with reference to a preferred embodiment, it will be understood by those skilled in the art that various changes in form and detail may be made therein without departing from the spirit and scope of the invention.

What is claimed is:

1. A method for making guacamole, said method comprising:
mixing avocado flesh with ingredients to produce said guacamole, wherein said ingredients comprise:
a sufficient amount of acid to produce an avocado blend having a pH less than about 4.6;
at least one anti-microbial additive; and
at least one anti-browning additive;
packaging said guacamole to produce packaged guacamole inside a sealed container comprising material that has an oxygen permeability of less than 1 cubic centimeter of oxygen per square meter of material per day.

2. The method of claim 1 further comprising:
subjecting said packaged guacamole to a pressure of at least about 80,000 pounds per square inch for at least about 20 seconds.

3. The method of claim 1 further comprising:
heating said packaged guacamole to a temperature between about 130° F. and about 160° F. for between about 2 minutes and about 20 minutes.

4. The method of claim 1 further comprising:
heating said guacamole prior to packaging to a temperature between about 130° F. and about 160° F. for between about 2 minutes and about 20 minutes.

5. The method of claim 1 wherein said anti-microbial additive further comprises nicin.

6. The method of claim 1 wherein said anti-microbial additive further comprises a sorbic acid mineral salt.

7. The method of claim 1 wherein said anti-microbial additive further comprises cultured whey.

8. The method of claim 1 wherein said anti-microbial additive further comprises cultured dextrose.

9. The method of claim 1 wherein said anti-microbial additive further comprises benzoate.

10. The method of claim 1 wherein said anti-microbial additive further comprises a paraben.

11. The method of claim 1 wherein said anti-browning additive further comprises sulfur dioxide.

12. The method of claim 1 wherein said anti-browning additive further comprises a chelating agent.

13. The method of claim 1 wherein said anti-browning additive further comprises 1-cysteine.

14. The method of claim 1 wherein said anti-browning additive further comprises a chloride salt.

15. The method of claim 1 wherein said anti-browning additive further comprises an antioxidant.

16. The method of claim 1 further comprising:
performing said mixing and said packaging under clean room conditions comprising less than 100,000 particles larger than 0.5 micrometers per cubic foot of air.

17. The method of claim 1 wherein said packaging further comprises flushing said sealed container with a gas chosen from the group consisting of nitrogen, carbon monoxide and carbon dioxide.

18. The method of claim 1 wherein said packaging further comprises removing oxygen from inside said sealed container under a vacuum.

19. The method of claim 3 wherein said heating further comprises microwaving said guacamole.

20. The method of claim 2 wherein said pressure is at least about 90,000 pounds per square inch.

21. The method of claim 3 additionally comprising cooling said packaged guacamole to a temperature less than about 80° F.

22. The method of claim 1 wherein said packaging additionally comprises including an oxygen scavenger inside said sealed container.

23. The method of claim 22 wherein said oxygen scavenger comprises a sachet containing an iron powder covered with sea salt.

24. The method of claim 22 wherein said oxygen scavenger comprises a sachet containing a zeolite impregnated with a sodium chloride solution.

25. The method of claim 22 wherein said oxygen scavenger comprises an oxidizable polymer.

26. A guacamole comprising:
avocado flesh;
a pH less than about 4.6; and
a bacterial growth rate of approximately zero when measured at a pH of less than about 4.6.

27. The guacamole of claim 26 further comprising nicin.

28. The guacamole of claim 26 further comprising a sorbic acid mineral salt.

29. The guacamole of claim 26 further comprising cultured whey.

30. The guacamole of claim 26 further comprising cultured dextrose.

31. The guacamole of claim 26 further comprising benzoate.

32. The guacamole of claim 26 further comprising a paraben.

33. The guacamole of claim 26 further comprising sulfur dioxide.

34. The guacamole of claim 26 further comprising a chelating agent.

35. The guacamole of claim 26 further comprising 1-cysteine.

36. The guacamole of claim 26 further comprising a chloride salt.

37. The guacamole of claim 26 further comprising an antioxidant.

38. The guacamole of claim 26 further comprising at least one of acetic acid, ascorbic acid, fumaric acid, citric acid, tartaric acid, malic acid, phosphoric acid, gluconic, and lactic acid, and glucono delta lactone.

39. The guacamole of claim 26 further comprising a sealed container approximately surrounding said guacamole, wherein said sealed container comprises a material having an oxygen permeability of less than 1 cubic centimeter of oxygen per square meter of material per day.

40. The guacamole of claim 39 wherein said sealed container is flushed with a gas chosen from the group consisting of nitrogen, carbon monoxide and carbon dioxide.

41. The guacamole of claim 39 further comprising denatured polyphenol oxidase enzymes.

42. The guacamole of claim 26 wherein said guacamole is shelf-stable.

43. A system for making guacamole comprising:
a mixer adapted to mix avocado flesh with ingredients to produce said guacamole, said ingredients comprising:
a sufficient amount of acid to produce an avocado blend having a pH less than about 4.6;
an anti-microbial additive; and
an anti-browning additive;
a packager adapted to producing a scaled container of said guacamole, said sealed container comprising material that has an oxygen permeability of less than 1 cubic centimeter of oxygen per square meter of material per day.

44. The system of claim 43 further comprising:
a pressurizer capable of subjecting said sealed container of said guacamole to a pressure of at least about 80,000 pounds per square inch for at least about 20 seconds.

45. The system of claim 43 further comprising:
a heater capable of heating said sealed container of said guacamole to a temperature between about 130° F. and about 160° F. for between about 2 minutes and about 20 minutes.

46. The system of claim 43 further comprising:
a heater capable of heating said guacamole prior to packaging to a temperature between about 130° F. and about 160° F. for between about 2 minutes and about 20 minutes.

47. The system of claim 43 wherein said anti-microbial additive further comprises nicin.

48. The system of claim 43 wherein said anti-microbial additive further comprises a sorbic acid mineral salt.

49. The system of claim 43 wherein said anti-microbial additive further comprises cultured whey.

50. The system of claim 43 wherein said anti-microbial additive further comprises cultured dextrose.

51. The system of claim 43 wherein said anti-microbial additive further comprises benzoate.

52. The system of claim 43 wherein said anti-microbial additive further comprises a paraben.

53. The system of claim 43 wherein said anti-browning additive further comprises sulfur dioxide.

54. The system of claim 43 wherein said anti-browning additive further comprises a chelating agent.

55. The system of claim 43 wherein said anti-browning additive further comprises 1-cysteine.

56. The system of claim 43 wherein said anti-browning additive further comprises a chloride salt.

57. The system of claim 43 wherein said anti-browning additive further comprises an antioxidant.

58. The system of claim 43 wherein said ingredients further comprise less than 300,000 organisms per gram of said ingredients.

59. The system of claim 43 wherein said ingredients further comprise less than 100,000 organisms per gram of said ingredients.

60. The system of claim 43 wherein said ingredients further comprise approximately zero organisms per gram of said ingredients.

61. The system of claim 43 wherein said mixer and said packager are operated under clean room conditions comprising less than 100,000 particles larger than 0.5 micrometers per cubic foot of air.

62. The system of claim 43 wherein said packager is capable of flushing said sealed container with a gas chosen from the group consisting of nitrogen, carbon monoxide and carbon dioxide.

63. The system of claim 43 wherein said packager is capable of removing oxygen from inside said sealed container under a vacuum.

64. The system of claim 45 wherein said heater further comprises a microwave.

65. The system of claim 44 wherein said pressure is at least about 90,000 pounds per square inch.

66. The system of claim 46 wherein said heater further comprises a microwave.
